(19) United States
(12) Patent Application Publication
(10) Pub. No.: US 2021/0131632 A1
(43) Pub. Date: May 6, 2021

(54) VEHICULAR LAMP FITTING

(71) Applicant: STANLEY ELECTRIC CO., LTD., Tokyo (JP)

(72) Inventors: Hiroaki KUROSU, Tokyo (JP); Takumi TANOKURA, Tokyo (JP); Hidetaka OKADA, Tokyo (JP)

(21) Appl. No.: 16/474,011

(22) PCT Filed: Dec. 22, 2017
(86) PCT No.: PCT/JP2017/046084

§ 371 Date: Jun. 26, 2019

(30) Foreign Application Priority Data
Dec. 26, 2016 (JP) 2016-251373

(51) Int. Cl. F21S 41/25; F21S 43/20; F21S 43/30

(52) U.S. Cl. CPC F21S 41/25; F21S 43/30; F21S 43/26

(57) ABSTRACT

A vehicular lamp fitting comprising a first light guiding lens which includes a first entry surface and a first exit surface, a second light guiding lens which is disposed below the first light guiding lens, and includes a second entry surface and a second exit surface, wherein a lower edge of the first exit surface of the first light guiding lens includes a first stepped edge and a first extended edge, an upper edge of the second exit surface of the second light guiding lens includes a second stepped edge having an inverted shape of the first edge, and a second extended edge, and the first light guiding lens and the second light guiding lens are disposed in a state where the first edge and the second edge are line-contacted, and a space is formed between the first extended edge and the second extended edge.

### TECHNICAL FIELD

The present invention relates to a vehicular lamp fitting, and more particularly to a vehicular lamp fitting which can form a plurality of types of light distribution patterns.

### BACKGROUND ART

A vehicular lamp fitting including: a light guiding lens which includes an entry surface and an exit surface; a light source (e.g. LED) configured to emit light to form a luminous intensity distribution on the exit surface when the light enters the light guiding lens through the entry surface and exits through the exit surface; and a projection lens configured to form a low beam light distribution pattern by inversely projecting the luminous intensity distribution formed on the exit surface, has been proposed (e.g. Patent Literature 1 (FIG. 1)).

### CITATION LIST

### Patent Literature

Patent Literature 1: Japanese Patent Application Publication No. 2015-79660

### SUMMARY OF INVENTION

### Problems to be Solved by the Invention

The vehicular lamp fitting according to Patent Literature 1, however, is capable of forming one type of light distribution pattern (low beam light distribution), but is incapable of forming a plurality of types of light distribution patterns (e.g. low beam light distribution and ADB light distribution pattern, or low beam light distribution pattern and high beam light distribution pattern).

With the foregoing in view, it is an object of the present invention to provide a vehicular lamp fitting which can form a plurality of types of light distribution patterns.

### Means for Solving the Problems

In order to achieve the object described above, an aspect of the present invention provides a vehicular lamp fitting, comprising:

a first light guiding lens which includes a first entry surface and a first exit surface;

a second light guiding lens which is disposed below the first light guiding lens, and includes a second entry surface and a second exit surface;

a first light source configured to emit light forming a luminous intensity distribution on the first exit surface when entering the first light guiding lens from the first entry surface and exiting from the first exit surface;

a second light source configured to emit light forming a luminous intensity distribution on the second exit surface when entering the second light guiding lens from the second entry surface and exiting from the second exit surface; and

a projection lens configured to inversely project the luminous intensity distributions formed on the first exit surface and the second exit surface in accordance with the lighting states of the first light source and the second light source,

wherein a lower edge of the first exit surface of the first light guiding lens includes a first stepped edge and a first extended edge disposed on both sides or on one side of the first edge;

an upper edge of the second exit surface of the second light guiding lens includes a second stepped edge having an inverted shape of the first edge, and a second extended edge disposed on both side or on one side of the second edge; and

the first light guiding lens and the second light guiding lens are disposed in a state where the first edge and the second edge are line-contacted, and a space is formed between the first extended edge and the second extended edge.

According to this aspect, a vehicular lamp fitting which can form a plurality of types of light distribution patterns is provided.

This is because this vehicular lamp fitting includes not only the first light guiding lens but also the second light guiding lens, and the projection lens inversely projects the luminous intensity distribution formed on the first exit surface of the first light guiding lens and the second exit surface of the second light guiding lens in accordance with the lighting states of the first light source and the second light source.

Further, according to this aspect, when the first light guiding lens and the second light guiding lens are combined, the first extended edge of the exit surface of the first light guiding lens and the second extended edge of the exit surface of the second light guiding lens contact before the first stepped edge of the first exit surface of the first light guiding lens and the upper edge of the second exit surface of the second light guiding lens are line-contacted, and deviation of the shapes of the optically critical regions can be prevented.

This is because the first light conducting lens and the second light conducting lens are disposed in a state where the first edge and the second edge are line-contacted, and a space is formed between the first extended edge and the second extended edge.

In addition, in a preferred aspect of the invention described above, the second extended edge is disposed at a position lower than the second edge in the vertical direction, so that a space is formed between the first extended edge and the second extended edge.

In addition, in a preferred aspect of the invention described above, the projection lens is disposed ahead of the first exit surface and the second exit surface; the back surface of the projection lens is a spherical surface which is convex toward the first exit surface and the second exit surface; and the first exit surface and the second exit surface are surface-contacted with the back surface of the projection lens.

In addition, in a preferred aspect of the invention described above, a reflection member is disposed between the lower end face of the first lighting guiding lens and the upper end face of the second lighting guiding lens.

### BRIEF DESCRIPTION OF DRAWINGS

FIG. 1 is a perspective view depicting a vehicular lamp fitting 10.

FIG. 2A is a top view, FIG. 2B is a front view, and FIG. 2C is a side view of the vehicular lamp fitting 10.

FIG. 3 is a cross-sectional view of the vehicular lamp fitting 10 illustrated in FIG. 1 sectioned at a horizontal plane which includes the reference axis AX (plane which includes the X axis and the Y axis).

FIG. 4 is a cross-sectional view of the vehicular lamp fitting 10 illustrated in FIG. 1 sectioned at a vertical plane which includes the reference axis AX (plane which includes the X axis and the Z axis).

FIG. 5 is an exploded perspective view of the vehicular lamp fitting 10.

FIG. 6 is a perspective view of the holder 40.

FIG. 7 is a perspective view of a structure constituted by the heat sink 20, the light source module 30, the holder 40 and the separator 50.

FIG. 8 is a perspective view of the separator 50.

FIG. 9A is a front view of upper separator main body 52, FIG. 9B is a front view of lower separator main body 53, and FIG. 9C is a front view (perspective view) of the plurality of low beam light sources 32a and the plurality of ADB light sources 32b when viewed through the separator 50.

FIGS. 10A and 10B are diagrams depicting a relationship of the convex portion 48 of the holder 40, the separator 50 and the primary lens 60.

FIG. 11A is an example of low beam light distribution pattern P_{Lo}, FIG. 11B is an example of ADB light distribution pattern PADB, FIG. 11C is an example of a composite light distribution pattern which includes a low beam light distribution pattern PLo and an ADB light distribution pattern PADB, FIG. 11D is a diagram showing a state in which a plurality of regions (for example, a plurality of regions A1 to A4 individually turned on and off) constituting the ADB light distribution pattern are circularly overlapped.

### DESCRIPTION OF EMBODIMENTS

A vehicular lamp 10 (corresponding to a vehicular headlamp according to the present invention) according to an embodiment of the present invention is described below with reference to the attached drawings. Corresponding components in each drawing are denoted by the same reference symbols and overlapping descriptions are omitted.

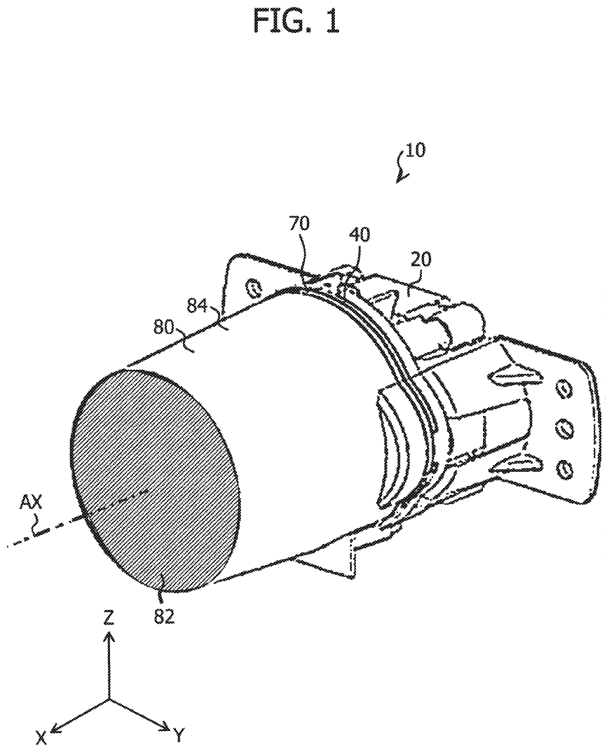

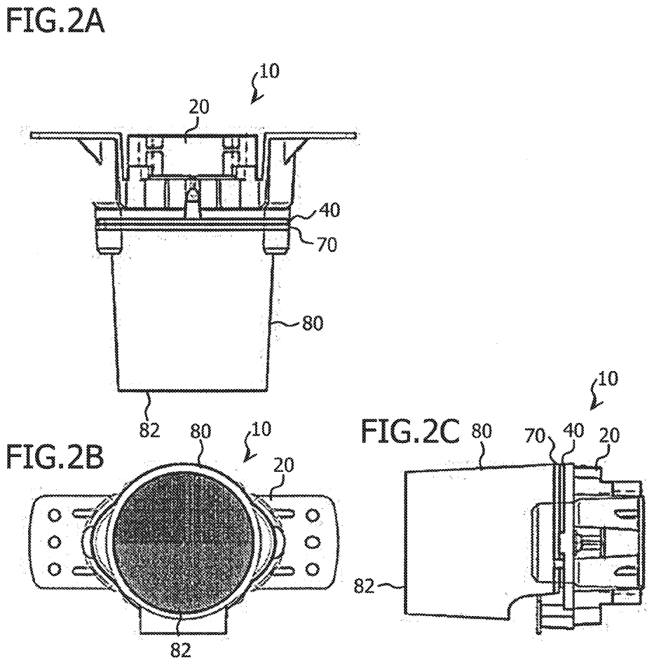

FIG. 1 is a perspective view depicting a vehicular lamp fitting 10. FIG. 2A is a top view, FIG. 2B is a front view, and FIG. 2C is a side view of the vehicular lamp fitting 10.

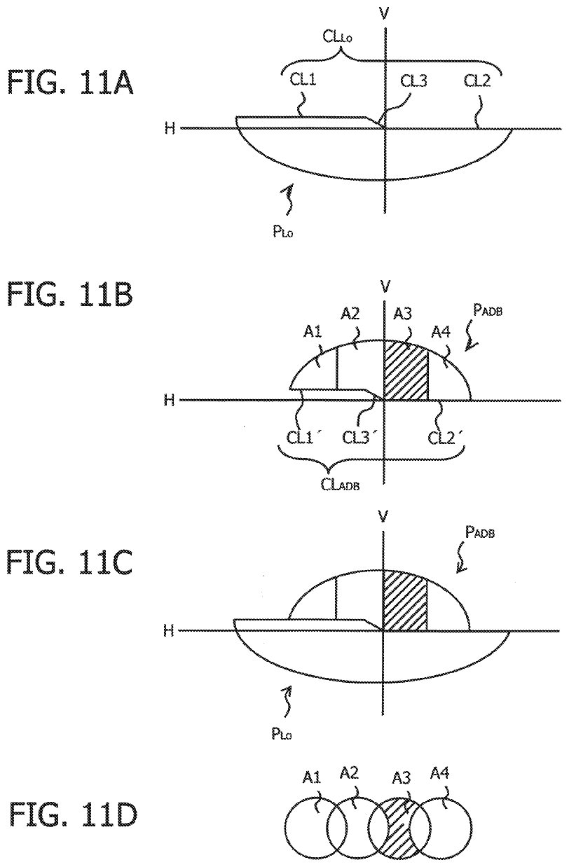

The vehicular lamp fitting 10 illustrated in FIG. 1 and FIG. 2 is a vehicular head light that can form a low beam light distribution pattern P_{Lo} (see FIG. 11A) or a composite light distribution pattern (see FIG. 11C) which includes a low beam light distribution pattern P_{Lo} and an ADB light distribution pattern P_{ADB}, and is mounted on the left and right of the front end of a vehicle (not illustrated). The low beam light distribution pattern P_{Lo} and the ADB light distribution pattern P_{ADB} are formed on a virtual vertical screen (formed at about 25 m ahead of the front surface of the vehicle) which faces the front surface of the vehicle. To make explanation easier, the X, Y and Z axes are defined. The X axis extends in the vehicle length direction, the Y axis extends in the vehicle width direction, and the Z axis extends in the vertical direction.

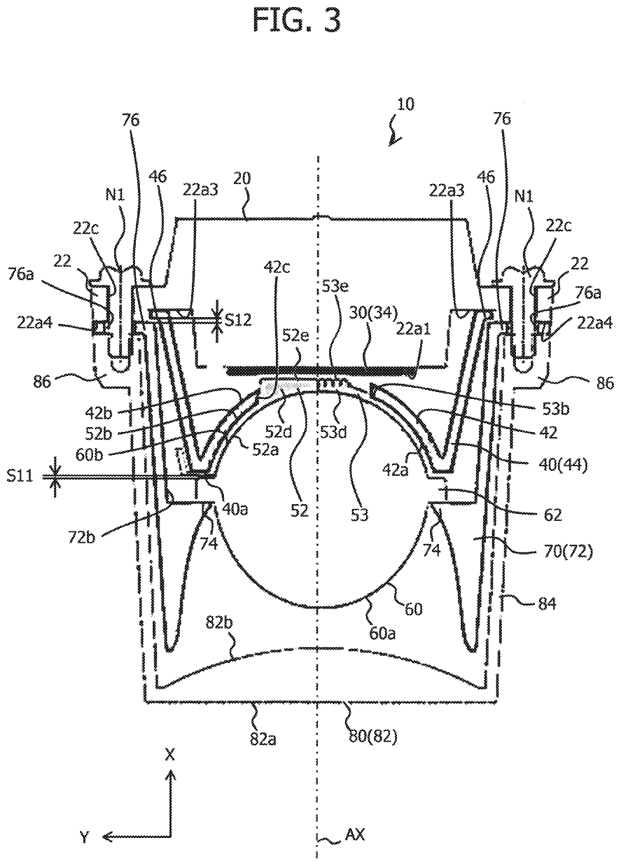

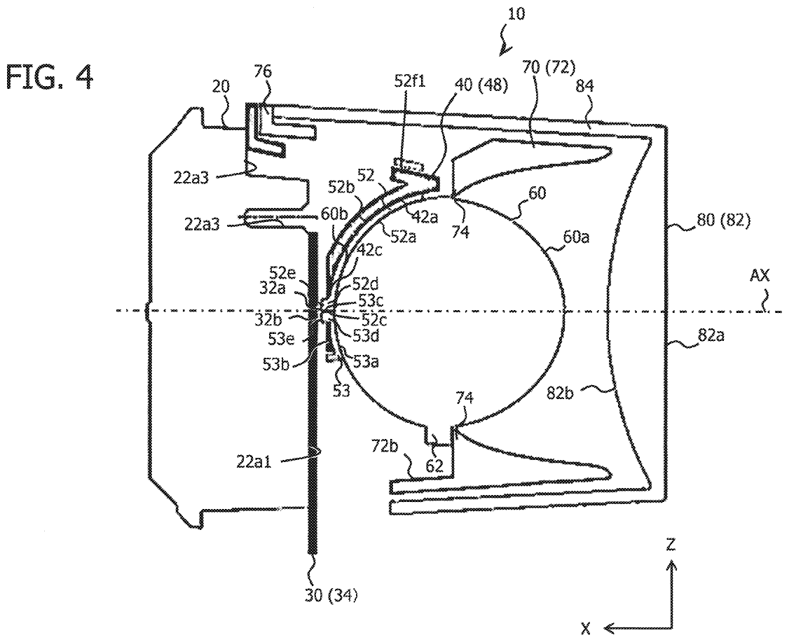

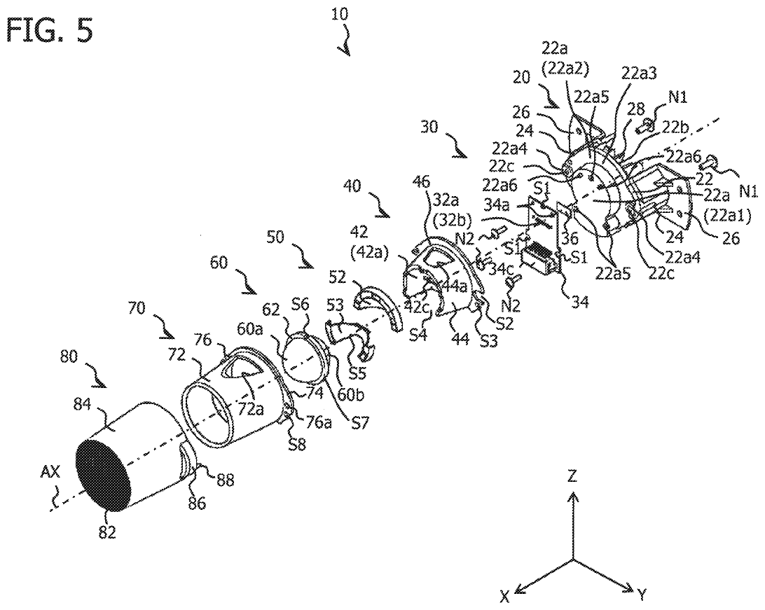

FIG. 3 is a cross-sectional view of the vehicular lamp fitting 10 illustrated in FIG. 1 sectioned at a horizontal plane which includes the reference axis AX (plane which includes the X axis and the Y axis). FIG. 4 is a cross-sectional view of the vehicular lamp fitting 10 illustrated in FIG. 1 sectioned at a vertical plane which includes the reference axis AX (plane which includes the X axis and the Z axis). FIG. 5 is an exploded perspective view of the vehicular lamp fitting 10.

As illustrated in FIG. 3 to FIG. 5, the vehicular lamp fitting 10 of this embodiment includes a heat sink 20, a light source module 30, a holder 40, a separator 50, a primary lens 60, a retainer 70, a secondary lens 80 and the like. The vehicular lamp fitting 10 is disposed in a lamp chamber (not illustrated) constituted by an outer lens and a housing, and is installed in the housing.

As illustrated in FIG. 5, the heat sink 20, which is made of die cast aluminum, includes a base 22 having a front surface 22a, and a back surface 22b on the opposite side of the front surface 22a.

The front surface 22a includes a light source module mounting surface 22a1, and a peripheral surface 22a2 surrounding the light source module mounting surface 22a1.

The light source module mounting surface 22a1 and the peripheral surface 22a2 are planes that are parallel with a plane which includes the Y axis and the Z axis, for example.

The thickness between the light source module mounting surface 22a1 and the back surface 22b (thickness in the X axis direction) is thicker than the thickness between the peripheral surface 22a2 and the back surface 22b (thickness in the X axis direction), whereby a step difference is formed.

In the light source module mounting surface 22a1, screw holes 22a5 (three locations in FIG. 3) are disposed to fix the light source module 30 by screwing. In the light source module mounting surface 22a1, positioning pins 22a6 (two locations in FIG. 3) are disposed to position the light source module 30.

The peripheral surface 22a2 includes a holder contact surface 22a3 with which the holder 40 contacts, and a retainer contact surface 22a4 with which the retainer 70 contacts.

The retainer contact surface 22a4 is disposed on the left and right side of the peripheral surface 22a2 respectively.

The thickness between the retainer contact surface 22a4 and the back surface 22b (thickness in the X axis direction) is thicker than the thickness between the holder contact surface 22a3 and the back surface 22b (thickness in the X axis direction), whereby a step difference is formed.

In the base 22, screw holes 22c (two locations in FIG. 3), where screws N1 are inserted, are disposed. The screw holes 22c penetrate the retainer contact surface 22a4 and the back surface 22b.

On the left and right sides of the base 22, the first extended edge 24 is formed, so as to extend backward (X axis direction) from the left and right sides of the base 22 respectively. On the front end of the first extended edge 24, a second extended edge portion 26 is formed so as to extend sideways (Y axis direction).

A radiation fin 28 is disposed on the back surface 22b of the base 22.

The light source module 30 includes: a plurality of low beam light sources 32a; a plurality of ADB light sources 32b; and a substrate 34 on which the plurality of low beam light sources 32a, the plurality of ADB alight sources 32b and a connector 34c are mounted. The plurality of light sources 32a correspond to the first light source of the present invention, and the plurality of light sources 32b correspond to the second light source of the present invention.

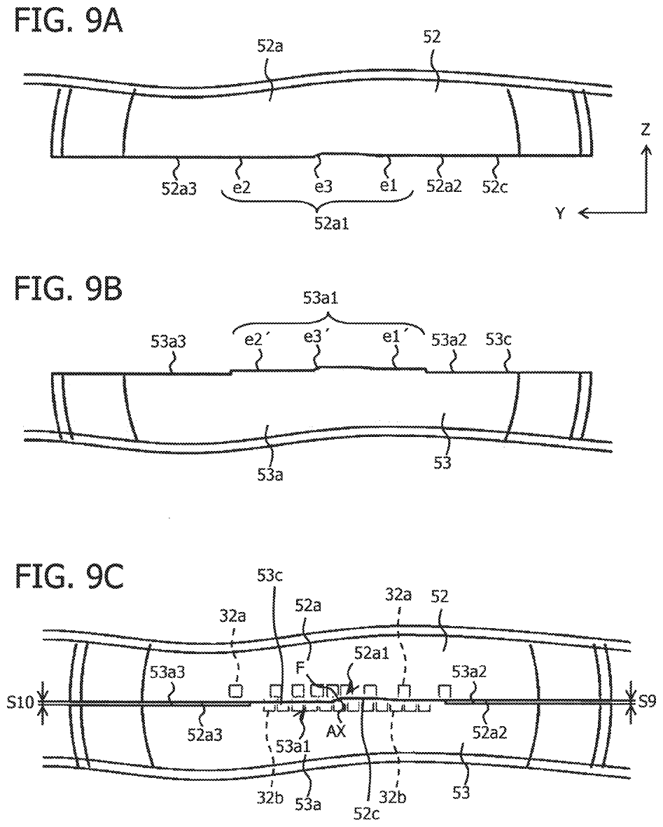

FIG. 9C is a front view (perspective view) of the plurality of low beam light sources 32a and the plurality of ADB light sources 32b when viewed through the separator 50.

As illustrated in FIG. 9C, the plurality of low beam light sources 32a are mounted on the substrate 34 on the upper stage in the Y axis direction. The plurality of ADB light sources 32b are mounted on the substrate 34 on the lower stage in the Y axis direction.

Each of the light sources 32a and 32b is a semiconductor light-emitting element (e.g. LED) having a rectangular light-emitting surface (e.g. 1 millimeter square), and is mounted on the substrate 34 in a state of each light-emitting source facing forward (front surface). Each of a plurality of rectangles in FIG. 9C indicates the light-emitting surface of the light source 32a or 32b respectively.

In the substrate 34, through holes 34a (two locations in FIG. 5) to which the positioning pins 22a6 of the heat sink 20 are inserted, and notches S1 (three locations in FIG. 5) to which screws N2 are inserted, are formed.

The light source module 30 having the above configuration is fixed to the heat sink 20 (light source module mounting surface 22a1) by screwing the screws N2 inserted in the notches S1 into the screw holes 22a5 of the heat sink 20 in a state where the positioning pins 22a6 of the heat sink 20 are inserted into the through holes 34a of the substrate 34. For this, a thermal conduction sheet 36 (or thermal grease) is disposed between the light source module 30 (substrate 34) and the heat sink 20 (light source module mounting surface 22a1), in order to increase adhesion between the light source module 30 (substrate 34) and the heat sink 20 (light source module mounting surface 22a1), and decrease contact thermal resistance. The thermal conduction sheet 36 is held between the light source module 30 (substrate 34) and the heat sink 20 (light source module mounting surface 22a1).

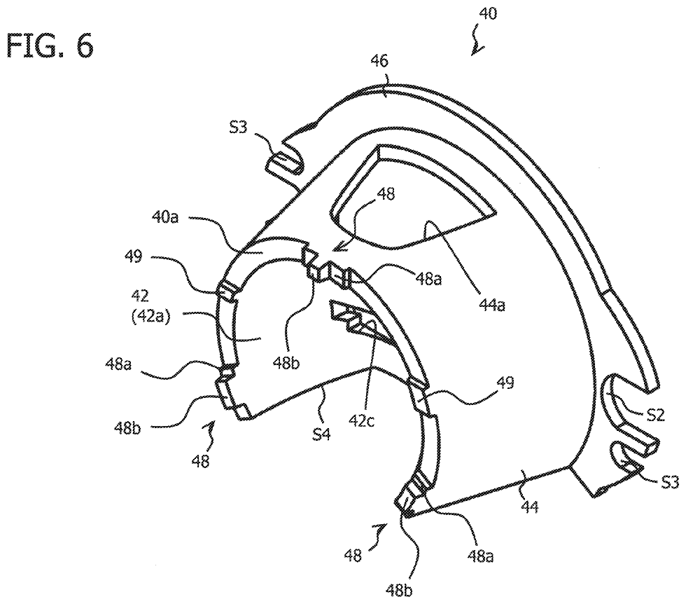

FIG. 6 is a perspective view of the holder 40.

As illustrated in FIG. 6, the holder 40 is made of synthetic resin (e.g. acrylic and polycarbonate), and includes a cup-shaped holder main body 42 of which front side is open and rear side is closed.

A front surface 42a of the holder main body 42 is configured as a surface having an inverted shape of the back surface of the separator 50 (back surface 52b of an upper separator main body 52 and a back surface 53b of the lower separator main body 53), so that the back surface of the separator 50 is surface-contacted.

In the holder main body 42, a through hole 42c, to which a light guiding unit 52d and a light guiding unit 53d of the separator 50 are inserted (e.g. press fitted or engaged), is formed. The through hole 42c penetrates through the front surface 42a and the back surface 42b of the holder main body 42 (see FIG. 3).

In the holder main body 42, a tubular unit 44, which extends backward (Z axis direction) from the peripheral portion of the holder main body 42, is disposed. In the tubular unit 44, a though hole 44a is formed to release heat, generated in the light source module 30, to the outside. At the front end of the tubular unit 44, a flange unit 46, which contacts (surface-contacts or appropriately surface-contacts) the holder contact surface 22a3 of the heat sink 20, is disposed.

In the flange unit 46, a notch S2 is formed so that the retainer contact surface 22a4 (step difference) of the heat sink 20 does not contact (interfere) with the flange unit 46. Further, The flange unit 46 is provided with a notch S3 into which a positioning pin 88 provided on the secondary lens 80 is inserted.

In the holder main body 42 (and the tubular unit 44), a notch S4 is formed so that the connector 34c of the light source module 30 does not contact (interfere) with the holder main body 42 (and the tubular unit 44).

In a front side opening end face 40a of the holder 40, convex portions 48 (three locations in FIG. 6) and convex portions 49 (two locations in FIG. 6) are disposed. The convex portion 48 includes a first convex portion 48a which protrudes forward from the front side opening end face 40a of the holder 40, and a second convex portion 48b which is narrower than the first convex portion 48a and protrudes forward from the first convex portion 48a. The convex portion 49 is a convex portion which protrudes forward from the front side opening end face 40a of the holder 40.

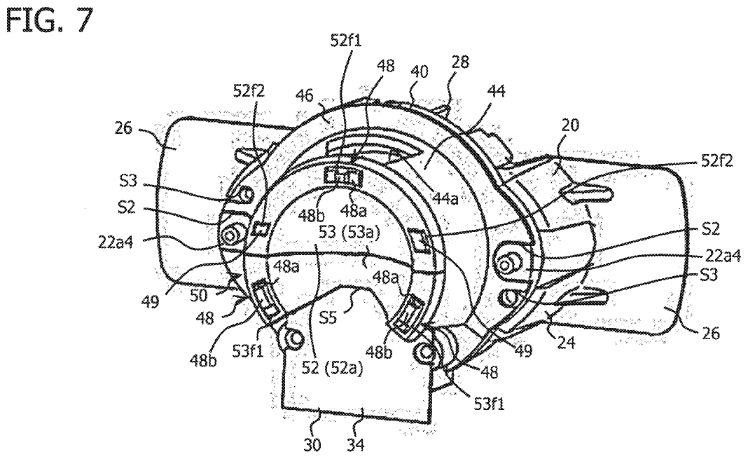

FIG. 7 is a perspective view of a structure constituted by the heat sink 20, the light source module 30, the holder 40 and the separator 50.

The holder 40 having the above configuration is disposed in a state where the retainer contact surface 22a4 (step difference) of the heat sink 20 is inserted into the notch S2 of the holder 40 (flange unit 46) (see FIG. 7), the flange unit 46 contacts the holder contact surface 22a3 of the heat sink 20 (see FIG. 3), and the through hole 42c and the light source module 30 (the plurality of light sources 32a and 32b) face each other (see FIG. 4).

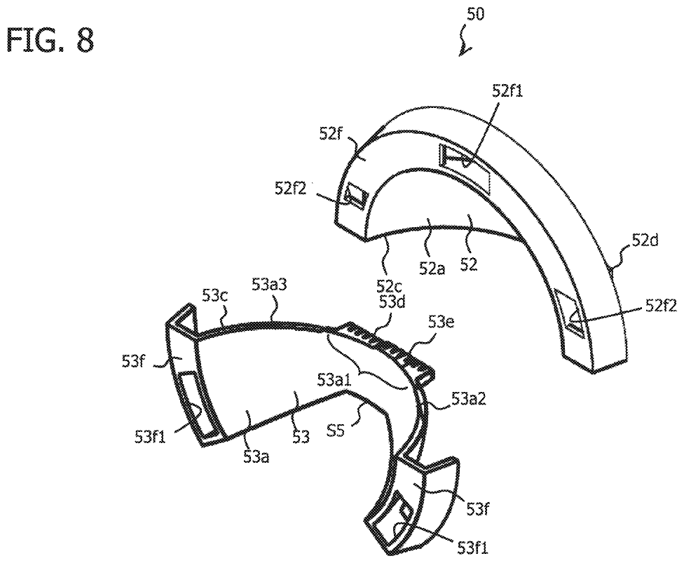

FIG. 8 is a perspective view of the separator 50.

As illustrate din FIG. 8, the separator 50 is a cup-shaped member made of silicon resin, of which front side is open and the rear side is closed. The separator 50 includes an upper separator main body 52 and a lower separator main body 53. The upper separator main body 52 corresponds to the first light guiding lens, and the lower separator main body 53 corresponds to the second light guiding lens. The separator 50 may be made of synthetic resin, such as acrylic and polycarbonate.

As illustrated in FIG. 4, the upper separator main body 52 is disposed above the reference axis AX, and the lower separator main body 53 is disposed below the reference axis AX. The reference axis AX extends in the X axis direction.

A front surface 52a of the upper separator main body 52 is configured as a surface having an inverted shape of the upper half above the reference axis AX of a back surface 60b of the primary lens 60 (spherical surface which is concave in the backward direction), so that the upper half of the back surface 60b of the primary lens 60 (spherical surface which is convex in the backward direction) is surface-contacted.

The back surface 52b of the upper separator main body 52 (see FIG. 3 and FIG. 4) is configured as a surface having an inverted shape of the upper half above the reference axis AX of the front surface 42a of the holder 40 (holder main body 42) (spherical surface which is convex in the backward direction), so that the upper half of the front surface 42a of the holder 40 (holder main body 42) (spherical surface which is concave in the forward direction) is surface-contacted.

As illustrated in FIG. 9A, the lower edge of the front surface 52a of the upper separator main body 52 includes a stepped edge 52a1 having a shape corresponding to the cut-off line CL_{Lo} (CL1 to CL3, see FIG. 11A), and extended edges 52a2 and 52a3 which are disposed on each side of the stepped edge 52a1. The extended edges 52a2 and 52a3 are optically unnecessary, but are disposed to hold the upper separator main body 52 during assembly. The stepped edge 52a1 corresponds to the first edge of the present invention. The extended edge may be disposed only on one side.

The stepped edge 52a1 includes an edge e1 corresponding to the left horizontal cut-off line CL1, an edge e2 corresponding to the right horizontal cut-off line CL2, and an edge e3 corresponding to the diagonal cut-off line CL3 connecting the left horizontal cut-off line CL1 and the right horizontal cut-off line CL2.

The extended edge 52a2 is disposed at a same position as the edge e1 with respect to the Z axis direction, and the extended edge 52a3 is disposed at a same position of the edge e2 with respect to the Z axis direction.

A lower end face 52c of the upper separator main body 52 (see FIG. 4) is a surface which extends from the lower edge of the front surface 52a of the upper separator main body 52 toward the back surface 52b of the upper separator main body 52 in the horizontal direction (X axis direction).

As illustrated in FIG. 3 and FIG. 4, the light guiding unit 52d is disposed on the back surface 52b of the upper separator main body 52, in order to guide the light from the light source module 30 (a plurality of light sources 32a). The light guiding unit 52d, of which base end is disposed on a partial region including the stepped edge 52a1, out of the back surface 52b of the upper separator main body 52, extends toward the light source module 30 (the plurality of light sources 32a). The partial region including the stepped edge 52a1 is a region of the back surface 52b of the upper separator main body 52, to which the light source module 30 (light-emitting surfaces of the plurality of light sources 32a) faces. The light guiding unit 52d is inserted into the through hole 42c of the holder 40.

At the front end of the light guiding unit 52d, an entry surface 52e is disposed. The entry surface 52e is in a plane that is parallel with the plane which includes the Y axis and the Z axis, for example. The entry surface 52e corresponds to the first entry surface, and the front surface 52a corresponds to a first exit surface of the present invention.

The entry surface 52e is disposed at a position facing the light source module 30 (light-emitting surfaces of the plurality of light sources 32a) in a state where the light guiding unit 52d is inserted into the through hole 42c of the holder 40 (see FIG. 4). The distance between the entry surface 52e and the light source module 30 (light-emitting surfaces of the plurality of light sources 32a) is 0.2 mm, for example.

As illustrated in FIG. 5 and FIG. 8, a flange unit 52f is disposed on the front side end face of the upper separator main body 52. In the flange unit 52f, a through hole 52f1 (one location in FIG. 5 and FIG. 8), to which the convex portion 48 of the holder 40 is inserted, and through holes 52f2 (two locations in FIG. 5 and FIG. 8) to which the convex portions 49 of the holder 40 are inserted are disposed.

The front surface 53a of the lower separator main body 53 is configured as a surface having an inverted shape of the lower half below the reference axis AX of the back surface 60b of the primary lens 60 (spherical surface which is concave in the backward direction), so that the lower half of the back surface 60b of the primary lens 60 (spherical surface which is convex in the backward direction) is surface-contacted.

The back surface 53b of the lower separator main body 53 (see FIG. 3 and FIG. 4) is configured as a surface having an inverted shape of the lower half below the reference axis AX of the front surface 42a of the holder 40 (holder main body 42) (spherical surface which is convex in the backward direction), so that the lower half of the front surface 42a of the holder 40 (holder main body 42) (spherical surface which is concave in the forward direction) is surface-contacted.

As illustrated in FIG. 9B, the upper edge of the front surface 53a of the lower separator main body 53 includes a stepped edge 53a1 (edges e1′ to e3′) having an inverted shape of the stepped edge 52a1 and extended edges 53a2 and 53a3 which are disposed on each side of the stepped edge 53a1. The extended edges 53a2 and 53a3 are optically unnecessary, but are disposed to hold the lower separator main body 53 during assembly. The stepped edge 53a1 corresponds to the second edge of the present invention. The extended edge may be disposed only on one side.

The extended edge 53a2 is disposed at a position lower than the edge e1′ with respect to the Z axis direction, so that a space S9 (see FIG. 9C) is formed between this extended edge 53a2 and the extended edge 52a2 of the front surface 52a of the upper separator main body 52 (see FIG. 9B). In the same manner, the extended edge 53a3 is disposed at a position lower than the edge e2′ with respect to the Z axis direction (see FIG. 9B), so that a space S10 (see FIG. 9C) is formed between this extended edge 53a3 and the extended edge 52a3 of the front surface 52a of the upper separator main body 52.

Thereby when the upper separator main body 52 and the lower separator main body 53 are combined, as illustrated in FIG. 9C, the extended edges 52a2 and 52a3 of the front surface 52a of the upper separator main body 52 and the extended edges 53a2 and 53a3 of the front surface 53a of the lower separator main body 53 does not contact before (and after) the stepped edge 52a1 of the front surface 52a of the upper separator main body 52 and the stepped edge 53a1 of the front surface 53a of the lower separator main body 53 are line-contacted. As a result, deviation of the shapes of the optically critical regions can be prevented. The optically critical regions are mainly regions where the luminous intensity distribution corresponding to the low beam light distribution pattern is formed, out of the front surface 52a of the upper separator main body 52, and a region where the luminous intensity distribution corresponding to the ADB light distribution pattern is formed, out of the front surface 53a of the lower separator main body 53.

The upper end face 53c of the lower separator main body 53 (see FIG. 4) is a surface which extends from the upper edge of the front surface 53a of the lower separator main body 53 toward the back surface 53b of the lower separator main body 53 in the horizontal direction (X axis direction).

As illustrated in FIG. 3 and FIG. 4, the light guiding unit 53d is disposed on the back surface 53b of the lower separator main body 53, in order to guide the light from the light source module 30 (the plurality of light sources 32b). The light guiding unit 53d, of which base end is disposed on a partial region including the stepped edge 53a1, out of the back surface 53b of the lower separator main body 53, extends toward the light source module 30 (the plurality of light sources 32b). The partial region including the stepped edge 53a1 is a region of the back surface 53b of the lower separator main body 53, to which the light source module 30 (light-emitting surfaces of the plurality of light sources 32b) faces. The light guiding unit 53d is inserted into the through hole 42c of the holder 40.

At the front end of the light guiding unit 53d, an entry surface 53e is disposed. The entry surface 53e is a surface that is adjusted such that a plurality of regions constituting the ADB light distribution pattern (e.g. a plurality of regions A1 to A4 which are independently turned ON/OFF) are formed in a state of being divided by the vertical edges, as illustrated in FIG. 11B, preventing these plurality of regions from becoming circles and overlapping with each other, as illustrated in FIG. 11D. FIG. 11B and FIG. 11D are ADB light distribution patterns that are formed when a number of ADB light sources 32b is four. A hatched region in FIG. 11B and FIG. 11D is a region where the light source 32b, corresponding to this region, is turned OFF. The entry surface 53e corresponds to the second entry surface of the present invention, and the front surface 53a corresponds to the second exit surface of the present invention.

The entry surface 53e is disposed at a position facing the light source module 30 (light-emitting surfaces of the plurality of light sources 32b) in a state where the light guiding unit 53d is inserted into the through hole 42c of the holder 40 (see FIG. 4). The distance between the entry surface 53e and the light source module 30 (light-emitting surfaces of the plurality of light sources 32b) is 0.2 mm, for example.

As illustrated in FIG. 5 and FIG. 8, a flange unit 53f is disposed on the front side end face of the lower separator main body 53. In the flange unit 53f, through holes 53f1 (two locations in FIG. 5 and FIG. 8) to which the convex portions 48 of the holder 40 are inserted are disposed.

In the lower separator main body 53, a notch S5 is formed so that the connector 34c of the light source module 30 does not contact (interfere) with the lower separator main body 53.

As illustrated in FIG. 9C, the upper separator main body 52 and the lower separator main body 53 are combined and constitute the separator 50, in a state where the stepped edge 52a1 of the front surface 52a of the upper separator main body 52 and the stepped edge 53a1 of the front surface 53a of the lower separator main body 53 are line-contacted, and the spaces S9 and S10 are formed between the extended edges 52a2 and 52a3 of the front surface 52a of the upper separator main body 52 and the extended edges 53a2 and 53a3 of the front surface 53a of the lower separator main body 53 respectively. In this state, the lower end face of the upper separator main body 52 and the upper end face of the lower separator main body 53 are surface-contacted in the range of the stepped edge 52a1 of the upper separator main body 52 and the stepped edge 53a1 of the lower separator main body 53 (see FIG. 4).

The separator 50 having the above configuration is disposed in a state where the light guiding unit 52d of the upper separator main body 52 and the light guiding unit 53d of the lower separator main body 53 are inserted (e.g. press-fitted or engaged) into the through holes 42c of the holder 40, the entry surface 52e of the upper separator main body 52 (light guiding unit 52d) and the light source module 30 (light-emitting surfaces of the plurality of light sources 32a) face each other, the entry surface 53e of the lower separator main body 53 (light guiding unit 53d) and the light source module 30 (light-emitting surfaces of the plurality of the light sources 32b) face each other (see FIG. 3 and FIG. 4), and the back surface of the separator 50 (back surface 52b of the upper separator main body 52 and the back surface 53b of the lower separator main body 53) is surface-contacted with the front surface 42a of the holder 40 (holder main body 42) (see FIG. 3 and FIG. 4).

Here the convex portions 48 of the holder 40 are inserted into the through hole 52f1 of the upper separator main body 52 and the through holes 53f1 of the lower separator main body 53 (see FIG. 7). Further, the convex portion 49 of the holder 40 is inserted into the through holes 52f2 of the upper separator main body 52 (see FIG. 7).

It is preferable to dispose a reflection member between the lower end face of the upper separator main body 52 and the upper end face of the lower separator main body 53. Then the leakage of the light from the light sources 32a and 32b through the lower end face of the upper separator main body 52 and the upper end face of the lower separator main body 53 can be suppressed. For the reflection member, a white coating (or thin white film) formed at least on one of the lower end face of the upper separator main body 52 and the upper end face of the lower separator main body 53, or a thin white plate disposed between the lower end face of the upper separator main body 52 and the upper end face of the lower separator main body 53, for example, can be used.

As illustrated in FIG. 5, the primary lens 60 is a spherical lens which includes the front surface 60a and the back surface 60b on the opposite side of the front surface 60a. The front surface 60a is a spherical surface which is convex in the forward direction, and the back surface 60b is a spherical surface which is convex in the backward direction. The flange unit 62 is disposed in the primary lens 60. The flange unit 62 is optically unnecessary, but is disposed to hold the primary lens 60 during assembly. The flange unit 62 extends between the front surface 60a and the back surface 60b so as to surround the reference axis AX. In the flange unit 62, a notch S6, to which the second convex portion 48b of the convex portion 48 of the holder 40 is inserted, and an opening S7 (with a bottom face) to which the second convex portion 48b of the convex portion 48 of the holder 40 is inserted, are disposed.

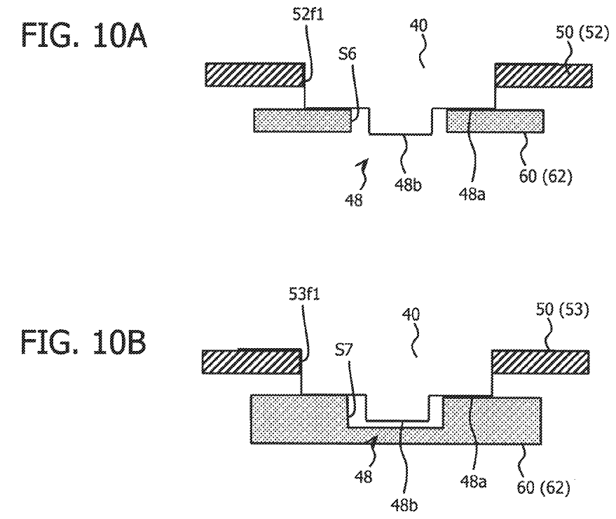

FIG. 10 is a diagram depicting a relationship of the convex portion 48 of the holder 40, the separator 50 and the primary lens 60.

The primary lens 60 having the above configuration is disposed in a state where the second convex portion 48b of the convex portion 48 of the holder 40 is inserted into the notch S6 of the flange unit 62 (see FIG. 10A), the first convex portion 48a of the convex portion 48 contacts the flange unit 62 (see FIG. 10A), the second convex portion 48b of the convex portion 48 of the holder 40 is inserted into the opening S7 of the flange unit 62 (see FIG. 10B), the first convex portion 48a of the convex portion 48 is contacted with the flange unit 62 (see FIG. 10B), and the back surface 60b of the primary lens 60 is surface-contacted with the front surface of the separator 50 (the front surface 52a of the upper separator main body 52 and the front surface 53a of the lower separator main body 53) (see FIG. 3 and FIG. 4).

When the first convex portions 48a (three locations) of the convex portion 48 formed in the front side opening end face 40a of the holder 40 contact the flange unit 62 of the primary lens 60 like this, the primary lens 60 is positioned with respect to the holder 40 (and the separator 50). Thereby a space 511 (see FIG. 3) is formed between a portion other than the front surface of the separator 50 (the front surface 52a of the upper separator main body 52 and the front surface 53a of the lower separator main body 53), that is, a portion other than the optical surface, and the primary lens 60 (particularly the flange unit 62). The convex portion 48 may be omitted. Even if the convex portion 48 is omitted, the space S11 (see FIG. 3) can be formed between the portion other than the front surface of the separator 50 (a portion other than the optical surface) and the primary lens 60 (particularly the flange unit 62), by moving the position of the front side opening end face 40a of the holder 40 backward with respect to the primary lens 60 (particularly the flange unit 62).

By forming this space S11, the contact between the portion other than the front surface of the separator 50 (a portion other than the optical surface) and the primary lens 60 (particularly the flange unit 62) can be prevented. As a result, unnecessary pressure to the separator 50 is not applied, hence deformation of the separator 50 can be prevented.

As illustrated in FIG. 5, the retainer 70 is made of synthetic resin (e.g. acrylic and polycarbonate), and includes a retainer main body 72, which is a tubular body which conically widens from the front side opening end face to the rear side opening end face.

In the retainer main body 72, a through hole 72a is formed to release the heat generated in the light source module 30 to the outside.

As illustrated in FIG. 3 and FIG. 4, a pressor 74, which contacts the flange unit 62 of the primary lens 60 and presses the primary lens 60 (flange unit 62), is disposed on an inner peripheral surface 72b of the retainer main body 72. The pressor 74 extends in the circumferential direction of the inner peripheral surface 72b of the retainer main body 72.

At the front end of the retainer main body 72, a flange unit 76, which contacts (surface-contacts or approximately surface-contacts) the retainer contact surface 22a4 of the heat sink 20, is disposed.

In the flange unit 76, a notch S8, to which the positioning pin 88 disposed in the secondary lens 80 is inserted, is disposed. A screw hole 76a, to which the screw N1 is inserted, is also disposed in the flange unit 76.

The retainer 70 having the above configuration is disposed in a state where the pressor 74 contacts the flange unit 62 of the primary lens 60 (see FIG. 3 and FIG. 4), and the flange unit 76 contacts the retainer contact surface 22a4 of the heat sink 20 (see FIG. 3).

When the flange unit 76 contacts the retainer contact surface 22a4 (step difference) of the heat sink 20, the vicinity of the flange unit 76 and the holder 40 (mainly the vicinity of the flange unit 46) do not contact, and a space S12 (see FIG. 3) is formed there between.

By forming this space S12, the contact between the vicinity of the flange of the flange unit 76 and the holder 40 (mainly vicinity of the flange unit 46) can be prevented, and unnecessary pressure to the separator 50 is not applied, hence deformation of the separator 50 can be prevented.

As illustrated in FIG. 5, the secondary lens 80 is made of synthetic resin (e.g. acrylic and polycarbonate), and includes a lens main body 82.

The lens main body 82 includes a front surface 82a and a back surface 82b on the opposite side of the front surface 82a (see FIG. 3 and FIG. 4). The front surface 82a is a plane that is parallel with the plane which includes the Y axis and Z axis, and the back surface 82b is a spherical surface which is convex in the backward direction.

On the outer periphery of the lens main body 82, a tubular unit 84, which extends from the outer periphery of the lens main body 82 in the backward direction (X axis direction), is disposed. At the front end of the tubular unit 84, a pressor/screw receiving unit 86, which contacts a flange unit 76 of the retainer 70 and presses the retainer 70 (flange unit 76), is disposed. The pressor/screw receiving unit 86 is disposed on the left and right sides of the tubular unit 84 respectively. Further, in the lens main body 82, the positioning pin 88, which is inserted into the notch S8 of the retainer 70, a notch S3 of the holder 40, and the opening of the heat sink 20, are disposed.

The primary lens 60 and the secondary lens 80 constitute the projection lens of which focal point F (see FIG. 9C) is located in the vicinity of the lower edge (stepped edge 52a1) of the front surface 52a of the upper separator main body 52 and the upper edge (stepped edge 53a1) of the front surface 53a of the lower separator main body 53. The curvature of field (rear focal plane) of this projection lens approximately matches the lower edge (stepped edge 52a1) of the front surface 52a of the upper separator main body 52 and the upper edge (stepped edge 53a1) of the front surface 53a of the lower separator main body 53.

For the primary lens 60 and the secondary lens 80 constituting this projection lens, the spherical lens and the plano-convex lens according to Japanese Patent Application Publication No. 2015-79660, for example, can be used.

The secondary lens 80 having the above configuration is disposed in a state where the positioning pin 88 is inserted into the notch S8 of the retainer 70, the notch S3 of the holder 40, and the opening of the heat sink 20; the lens main body 82 is disposed ahead of the primary lens 60; and the pressor/screw receiving unit 86 is in contact with the flange unit 76 of the retainer 70 (see FIG. 3 and FIG. 4).

Then, to the heat sink 20, the two screws N1 inserted into the screw hole 22c of the heat sink 20 and the screw hole 76a of the retainer 70 are screwed into the pressor/screw receiving unit 86, as illustrated in FIG. 3, in a state where the light source module 30, the holder 40, the separator 50, the primary lens 60, the retainer 70 and the secondary lens 80 are disposed in the heat sink, as mentioned above.

By screwing the two screws N1 into the pressor/screw receiving unit 86 like this, the retainer 70 (flange unit 76) is held between the heat sink 20 (retainer contact surface 22a4) and the secondary lens 80 (pressor/screw receiving unit 86), and the separator 50 and the primary lens 60 are held between the holder 40 (front surface 42a) and the retainer 70 (pressor 74) (see FIG. 3 and FIG. 4).

In concrete terms, the separator 50 is held in a state where the front surface (front surface 52a of the upper separator main body 52 and the front surface 53a of the lower separator main body 53) and the back surface 60b of the primary lens 60 are surface-contacted (see FIG. 3 and FIG. 4), and the back surface (back surface 52b of the upper separator main body 52 and the back surface 53b of the lower separator main body 53) and the front surface 42a of the holder 40 (holder main body 42) are surface-contacted (see FIG. 3 and FIG. 4). Thereby the separator 50 is positioned (mainly positioned in the longitudinal direction) with respect to the light source module 30. At this time, the separator 50 is held in a state where the portion other than the front surface (a portion other than the optical surface) and the primary lens 60 (particularly the flange unit 62) do not contact, and the space S11 (see FIG. 3) is formed there between.

The primary lens 60 is held in a state where the back surface 60b and the front surface of the separator 50 (the front surface 52a of the upper separator main body 52 and the front surface 53a of the lower separator main body 53) are surface-contacted (see FIG. 3 and FIG. 4), and the flange unit 62 and the pressor 74 of the retainer 70 are contacted (see FIG. 3 and FIG. 4). The retainer 70 (mainly flange unit 76) is held in a state where the vicinity of the flange unit 76 and the holder 40 (mainly the vicinity of the flange unit 46) are not contacted, and the space S12 (see FIG. 3) is formed there between.

In the state where the separator 50 and the primary lens 60 are held like this, as illustrated in FIG. 10, the second convex portion 48b of the convex portion 48 of the holder 40, which is inserted into the through hole 52f1 of the upper separator main body 52 (see FIG. 7), is inserted into the notch S6 of the flange unit 62 of the primary lens 60, and the first convex portion 48a of the convex portion 48 (see FIG. 7) contacts the flange unit 62 of the primary lens 60. The second convex portion 48b of the convex portion 48 of the holder 40, which is inserted into the through hold 53f1 of the lower separator main body 53 (see FIG. 7), is inserted into the opening S7 of the flange unit 62 of the primary lens 60, and the first convex portion 48a of the convex portion 48 contacts the flange unit 62 of the primary lens 60.

In the case of the vehicular lamp fitting 10 having the above configuration, when the plurality of low beam light sources 32a are turned ON, the lights from the plurality of low beam light sources 32a enter through the entry surface 52e of the light guiding unit 52d of the upper separator main body 52, are guided inside the light guiding unit 52d, and exit through the front surface 52a of the upper separator main body 52. Thereby a luminous intensity distribution corresponding to the low beam light distribution pattern is formed on the front surface 52a of the upper separator main body 52. This luminous intensity distribution includes the edges e1 to e3 (see FIG. 9A) corresponding to the cut-off line CL_{Lo} (CL1 to CL3). The projection lens constituted by the primary lens 60 and the secondary lens 80 inversely projects forward this light intensity distribution. Thereby the low beam light distribution pattern Pu, which includes the cut-off line CL (CL1 to CL3) at the upper edge, is formed, as illustrated in FIG. 11A.

When the plurality of ADB light sources 32b are turned ON, the lights from the plurality of ADB light sources 32b enter through the entry surface 53e of the light guiding unit 53d of the lower separator main body 53, are guided inside the light guiding unit 53d, and exit through the front surface 53a of the lower separator main body 53. Thereby a luminous intensity distribution corresponding to the ADB light distribution pattern is formed on the front surface 53a of the lower separator main body 53. This luminous intensity distribution includes the edges e1′ to e3′ (see FIG. 9B) corresponding to the cut-off line CL_{ADB} (CL1′ to CL3′). The projection lens constituted by the primary lens 60 and the secondary lens 80 inversely projects forward the light intensity distribution. Thereby the ADB light distribution pattern P_{ADB}, which includes the cut-off line CL_{ADB} (CL1′ to CL3′) in the lower edge, is formed, as illustrated in FIG. 11B. FIG. 11B indicates the ADB light distribution pattern P_{ADB} which is formed when a number of ADB light sources 32b is four. The hatched region in FIG. 11B indicates that the light source 32b, corresponding to this region, is turned OFF.

When the plurality of low beam light sources 32a and the plurality of ADB light sources 32b are turned ON, a composite light distribution pattern which includes the low beam light distribution pattern P_{Lo} and the ADB light distribution pattern P_{ADB} is formed, as illustrated in FIG. 11C.

In this way, a plurality of types of light distribution patterns are formed when the luminous intensity distribution formed on the front surface 52a of the upper separator main body 52 and the front surface 53a of the lower separator main body 53 are inversely projected in accordance with the lighting states of the plurality of light sources 32a and the plurality of light sources 32b.

As described above, according to this embodiment, the vehicular lamp fitting 10 which can form a plurality of types of light distribution patterns can be provided.

This is because the vehicular lamp fitting 10 includes not only the upper separator main body 52 but also the lower separator main body 53, and the projection lens (projection lens constituted by the primary lens 60 and the secondary lens 80) inversely projects the luminous intensity distribution formed on the front surface 52a of the upper separator main body 52 and the front surface 53a of the lower separator main body 53 in accordance with the lighting states of the light source 32a and the light source 32b.

Further, according to this embodiment, when the upper separator main body 52 and the lower separator main body 53 are combined, the extended edges 52a2 and 52a3 of the front surface 52a of the upper separator main body 52 and the extended edges 53a2 and 53a3 of the front surface 53a of the lower separator main body 53 contact before the stepped edge 52a1 of the front surface 52a of the upper separator main body 52 and the stepped edge 53a1 of the front surface 53a of the lower separator main body 53 are line-contacted, and deviation of the shapes of the optically critical regions can be prevented.

This is because the upper separator main body 52 and the lower separator main body 53 are disposed in a state where the stepped edge 52a1 and the stepped edge 53a1 are line-contacted, and the spaces S9 and S10 (see FIG. 9C) are formed between the extended edges 52a2 and 52a3 and the extended edges 53a2 and 53a3. The spaces S9 and S10 are formed because the extended edges 53a2 and 53a3 are disposed at a position lower than the stepped edge 53a1 in the vertical direction (see FIG. 9C).

Further, according to this embodiment, the leakage of the light from the light sources 32a and 32b through the lower end face of the upper separator main body 52 and the upper end face of the lower separator main body 53 can be suppressed.

This is because the reflection member is disposed between the lower end face of the upper separator main body 52 and the upper end face of the lower separator main body 53. The reflection member may be omitted.

Modifications will be described next.

In the above embodiment, an example when the holder 40 and the separator 50 are configured as physically separate components was described, but the configuration of the present invention is not limited to this. For example, the holder 40 and the separator 50 may be integrally molded as one component. This integrally molded component may be made of silicon resin, or made of synthetic resin (e.g. acrylic and polycarbonate).

In the above embodiment, an example when the lower separator main body 53 forms the ADB light distribution pattern P_{ADB} was described, but the configuration of the present invention is not limited to this. For example, the lower separator main body 53 may be configured to form the high beam light distribution pattern.

In the above embodiment, an example when a plurality of light sources 32a and a plurality of light sources 32b are used was described, but the configuration of the present invention is not limited to this. One light source 32a and one light source 32b may be used.

In the above embodiment, an example when the projection lens constituted of the primary lens 60 and the secondary lens 80 is used as the projection lens which inversely projects forward the luminous intensity distribution formed on the front surface of the separator 50 (the front surface 52a of the upper separator main body 52 and the front surface 53a of the lower separator main body 53), was described, but the configuration of the present invention is not limited to this. For example, for the projection lens, one lens may be used or a plurality of lenses may be used.

In the above embodiment, an example when the front surface of the separator 50 (the front surface 52a of the upper separator main body 52 and the front surface 53a of the lower separator main body 53) and the projection lens which inversely projects forward the luminous intensity distribution formed on the front surface of the separator 50 (the projection lens constituted of the primary lens 60 and the secondary lens 80) are surface-contacted (see FIG. 3 and FIG. 4), was described, but the configuration of the present invention is not limited to this. The projection lens can be any projection lens that can inversely project forward the luminous intensity distribution formed on the front surface of the separator 50 (the front surface 52a of the upper separator main body 52 and the front surface 53a of the lower separator main body 53), and the front surface of the separator 50 and the projection lens may not contact with each other. In other words, a space may be formed between the front surface of the separator 50 and the projection lens.

All the numeric values of each of the embodiments are given only for illustration purpose, and appropriate numeric values different from these numeric values can be, of course, used.

Each of the embodiments is given only for illustration purpose in all respects. The present invention is not limited to each of the embodiments in its interpretation. The present invention can be carried out in various ways without departing from its spirit or principal feature.

### REFERENCE SIGNS LIST

10 Vehicular lamp fitting
20 Heat sink
22 Base
22a Front surface
22a1 Light source module mounting surface
22a2 Peripheral surface
22a3 Holder contact surface
22a4 Retainer contact surface
22a5 Screw hole
22a6 Positioning pin
22b Back surface
22c Screw hole
24 First extended edge
26 Second extended edge
28 Radiation fin
30 Light source module
32a Light source
32b Light source
34 Substrate
34a Through hole
34c Connector
36 Thermal conduction sheet
40 Holder
40a Front side opening end face
42 Holder main body
42a Front surface
42b Back surface
42c Through hole
44 Tubular unit
44a Through hole
46 Flange unit
48 Convex portion
48a First convex portion
48b Second convex portion
49 Convex portion
50 Separator
52 Upper separator main body
52a Front surface
52a1 Stepped edge
52a2 Extended edge
52a3 Extended edge
52b Back surface
52c Lower end face
52d Light guiding unit
52e Entry surface
52f Flange unit
52f1 Through hole
52f2 Through hole
53 Lower separator main body
53a Front surface
53a1 Stepped edge
53a2 Extended edge
53a3 Extended edge
53b Back surface
53c Upper end face
53d Light guiding unit
53e Entry surface
53f Flange unit
53f1 Through hole
60 Primary lens
60a Front surface
60b Back surface
62 Flange unit
70 Retainer
72 Retainer main body
72a Through hole
72b Inner peripheral surface
74 Pressor
76 Flange unit
76a Screw hole
80 Secondary lens
82 Lens main body
82a Front surface
82b Back surface
84 Tubular unit
86 Pressor/screw receiving unit
88 Positioning pin
A1 to A4 Regions
AX Reference axis
CL Cut-off line
CL1 Left horizontal cut-off line
CL2 Right horizontal cut-off line
CL3 Cut-off line
CL_{ADB} Cut-off line
CL_{Lo} Cut-off line
F Focal point
N1, N2 Screws
P_{ADB} ADB light distribution pattern
P_{LO} Low beam light distribution pattern
S1 to S6, S8 Notches
S7 Opening
S9 to S12 Spaces
e1, e1′, e2, e2′, e3 Edges

1. A vehicular lamp fitting comprising:
a first light guiding lens which includes a first entry surface and a first exit surface;
a second light guiding lens which is disposed below the first light guiding lens, and includes a second entry surface and a second exit surface;
a first light source configured to emit light forming a luminous intensity distribution on the first exit surface when entering the first light guiding lens from the first entry surface and exiting from the first exit surface;
a second light source configured to emit light forming a luminous intensity distribution on the second exit surface when entering the second light guiding lens from the second entry surface and exiting from the second exit surface; and
a projection lens configured to inversely project the luminous intensity distributions formed on the first exit surface and the second exit surface in accordance with the lighting states of the first light source and the second light source,
wherein a lower edge of the first exit surface of the first light guiding lens includes a first stepped edge and a first extended edge disposed on both sides or on one side of the first edge;
an upper edge of the second exit surface of the second light guiding lens includes a second stepped edge having an inverted shape of the first edge, and a second extended edge disposed on both side or on one side of the second edge; and
the first light guiding lens and the second light guiding lens are disposed in a state where the first edge and the second edge are line-contacted, and a space is formed between the first extended edge and the second extended edge.

2. The vehicular lamp fitting according to claim 1, wherein the second extended edge is disposed at a position lower than the second edge in the vertical direction, so that a space is formed between the first extended edge and the second extended edge.

3. The vehicular lamp fitting according to claim 1,
wherein the projection lens is disposed ahead of the first exit surface and the second exit surface;
the back surface of the projection lens is a spherical surface which is convex toward the first exit surface and the second exit surface; and
the first exit surface and the second exit surface are surface-contacted with the back surface of the projection lens.

4. The vehicular lamp fitting according to claim 1, wherein a reflection member is disposed between the lower end face of the first lighting guiding lens and the upper end face of the second lighting guiding lens.

5. A light guiding lens, comprising: an upper light guiding lens that is disposed ahead of a first light source and guide light from the first light source; a lower light guiding lens that is disposed ahead of a second light source and guide light from the second light source, wherein
the upper light guiding lens includes: an upper light guiding lens main body that includes a front surface from which the light from the first light source emits and a back surface on the opposite side of the front face; a first light guiding unit which extends from a lower portion of the upper light guiding lens main body toward the first light source, and has a first entry surface facing the first light source at the front end,
the lower light guiding lens includes: a lower light guiding lens main body that includes a front surface from which the light from the second light source is emitted and a back surface on the opposite side of the front face; a second light guiding unit which extends from a upper portion of the lower light guiding lens main body toward the second light source, and has a second entry surface facing the second light source at the front end,
wherein a lower edge of the front surface of the upper light guiding lens includes a first stepped edge and a first extended edge disposed on both sides or on one side of the first edge;
an upper edge of the front surface of the lower light guiding lens includes a second stepped edge having an inverted shape of the first edge, and a second extended edge disposed on both side or on one side of the second edge; and
the upper light guiding lens and the lower light guiding lens are disposed in a state where the first edge and the second edge are line-contacted, and a space is formed between the first extended edge and the second extended edge.

6. A vehicular lamp fitting comprising: the light guiding lens according to claim 5; a projection lens disposed ahead of the light guiding lens; the first light source; the second light source, wherein
the first light source emits light, which enters the first light guiding unit from the first entry surface and emits from the front surface of the upper light guiding lens, to form a first light distribution pattern,
the second light source emits light, which enters the second light guiding unit from the second entry surface and emits from the front surface of the lower light guiding lens, to form a second light distribution pattern.

7. The vehicular lamp fitting according to claim 6,
wherein the first light distribution pattern is a low beam light distribution pattern,
the second light distribution pattern is an ADB light distribution pattern or a high beam light distribution pattern.
